(19) United States
(12) Patent Application Publication
(10) Pub. No.: US 2021/0289706 A1
(43) Pub. Date: Sep. 23, 2021

(54) FRUIT HARVESTING MACHINE

(71) Applicant: NOAM BLUM, GIVATON (IL)

(72) Inventor: NOAM BLUM, GIVATON (IL)

(21) Appl. No.: 17/203,911

(22) Filed: Mar. 17, 2021

(30) Foreign Application Priority Data
Mar. 18, 2020 (IL) 273421

(51) Int. Cl. A01D 46/253; A01D 46/24

(52) U.S. Cl. CPC A01D 46/253; A01D 46/243

(57) ABSTRACT

A fruit harvesting machine, including a sealed container (12), for collecting fruits, a vacuum pump (13), connected to the sealed container (12), for generating a vacuum in the sealed container (12), a flexible tube (14), connected to the sealed container (12), for drifting therethrough a fruit, a vehicle (28) on which the container a is placed on, a cutting device (27) located at the end (22) of the flexible tube (14), inside the tube, and a ladder (26) installed on the vehicle.

### TECHNICAL FIELD

The invention relates to the field of fruit harvesting technology, especially of sabra harvesting, but also of apple, plum, peach, orange, clementine, lemon, Chinese orange, tomato, pepper, strawberry, olive, and others.

### BACKGROUND

“Opuntia ficus-indica (prickly pear) is a species of cactus that has long been a domesticated crop plant grown in agricultural economies throughout arid and semiarid parts of the world. Likely having originated in Mexico, O. ficus-indica is the most widespread and most commercially important cactus. Common English names for the plant and its fruit are Indian fig opuntia, Barbary fig, cactus pear, prickly pear, and spineless cactus, among many. In Mexican Spanish, the plant is called nopal, while the fruit is called tuna, names that may be used in American English as culinary terms.” (From Wikipedia)

The growth of the sabra spread in the Land of Israel during the Ottoman Empire, which then served as a living platform for growing and harvesting cochineal insects for the production of a red dye, carmine.

Uses of Medicine

The sabra is very branchy, tree-like or shrub-like, and reaches up to five meters in height. The joints are elongated and about half a meter long and have yellow bristles. The fruits are reddish with a yellowish hue and are edible. In some types of Chinese medicine and natural homeopathy, its fruits are used for medicinal purposes to accelerate blood clotting.

Edible Uses

The sebum accumulates in its stems (a common mistake is to treat the plant stems as leaves, due to their deceptive appearance) and the rest of its organs contain a large amount of water so that it can pass the summer without drying out. The bush itself can also be used as a dish.” (From Wikipedia)

The fruit of the sabra resembles an egg shape, and is directly attached (=without stalk) to the plant.

It is customary to pick the back of the sack for edible purposes when it changes color from green to orange, so that when it reaches the markets it will be in marketing mode for some time. Cut the fruit at the point of attachment to the plant, and the emphasis is on cutting rather than tearing. By tearing a sabra fruit rather than cutting it, its shelf life is shortened.

One of the characteristics of the sabra plant is the thorns of the plant and fruit, which is why sabra picking is problematic. On the difficulty arising from the thorns of the sabra plant and the fruit must be added the height of the plant, which is about five meters, a fact which makes it difficult to harvest. The fruit of the sabra must be cut at its point of attachment to the plant.

FIG. 1 schematically illustrates a sabra plant, according to the prior art.

The plant 10 contains sabra fruits 11. As can be seen, the connection of the fruits 11 to the plant 10 is direct, i.e., not through a stalk.

The plant and fruit are thorny, which makes it difficult to harvest, especially in view of the height of the plant which may reach to about 5 meters.

To cut a fruit, a cut is applied at the location 21 where the fruit 11 connects to the plant 10. The fruit must not be torn but only cut; otherwise the quality of the fruit is damaged.

All of these features make sabra harvesting difficult, resulting in “high” cost, which is reflected in high prices.

Therefore, in order to make sabra harvesting economical, it is necessary to improve the harvesting work both in terms of harvesting ease and speed.

It should be noted that despite of the fact that the description above is refers to sabra harvesting, it characterizes other fruits that have a spherical/ellipsoidal form, such as apple, plum, peach, orange, clementine, lemon, Chinese orange, tomato, pepper, strawberry, olive, and others.

All the methods described above have not yet provided satisfactory solutions to the problem of fruits spherical/ellipsoidal fruits.

### SUMMARY

In one embodiment, the invention is directed to a fruit harvesting machine, comprising:

a sealed container (12), for collecting fruits;

a vacuum pump (13), connected to the sealed container (12), for generating a vacuum in the sealed container (12);

a flexible tube (14), connected to the sealed container (12), for drifting therethrough a fruit;

a vehicle (28) on which the sealed container is placed on; and

a ladder (26) installed on the vehicle,

thereby allowing harvesting fruits faster than harvesting without the vehicle, or without the vacuum pump, or without the flexible tube.

It should be noted that the term “vehicle” refers herein to any movable construction on wheels, whether motorized or dragged, including a car and a cart.

The term “vacuum pump” refers herein to a pump for drawing air from an enclosed space.

The machine may further comprise a cutting device (27) located at the inlet (22) of the flexible tube (14), whether it is mechanical or electrical.

The cutting device (27) may employ a rotating blade, a shutter, scissors, etc., for cutting the fruit from the plant, tree, etc.

In one embodiment, the ladder is adjustable. The adjustability may be of its length, tilt, etc.

In one embodiment, the machine comprises a vacuum release valve (29), for allowing releasing a door of the vacuum container.

In one embodiment, the machine comprises a door (15) for inserting therethrough a collecting basket (16) into the sealed container (12).

In one embodiment, the machine comprises a barrier (19) installed in the space of the sealed container, for blocking and softening a fall of a fruit (11) into the sealed container (12).

The machine may be adapted for harvesting apple, plum, peach, orange, clementine, lemon, Chinese orange, tomato, pepper, strawberry, olive, and other fruits. Such an adaption may be, for example, the dimension of the inlet (22) of the flexible tube (14).

In one embodiment, the machine is adapted for harvesting sabra fruit.

In another embodiment, the invention is directed to a fruit harvesting method, comprising:

providing a sealed container (12), for collecting fruits;

providing a vacuum pump (13), connected to the sealed container (12), for generating a vacuum in the sealed container (12);

providing a flexible tube (14), connected to the sealed container (12);

approaching an end of the tube (14) to a fruit,

thereby drifting the fruit into the tube.

According to one embodiment of the invention, the method further comprising the step of:

installing a cutting device (27) at an end (22) of the flexible tube (14); and

cutting the fruit by the cutting device,

thereby allowing cutting by the cutting device a fruit which is not drifted though the tube.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings:

FIG. 1 schematically illustrates a sabra plant, according to the prior art.

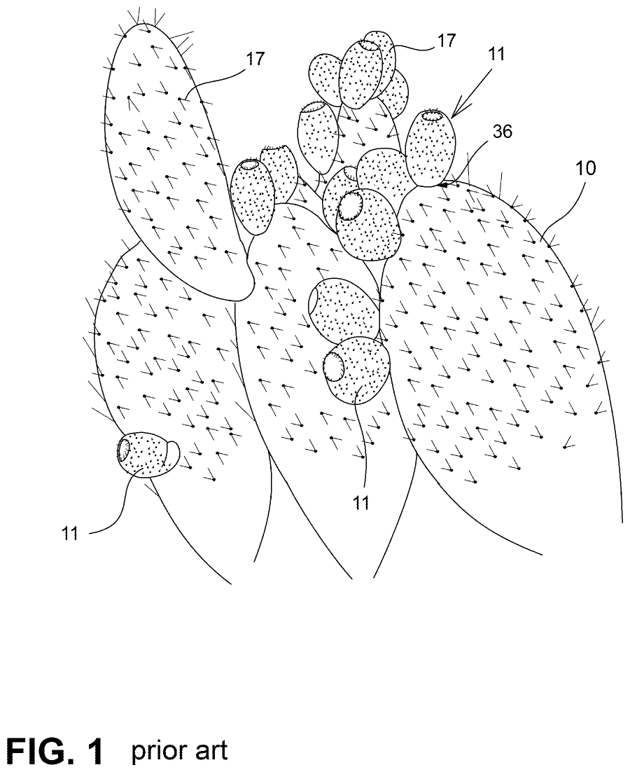

FIG. 2 schematically illustrates a sabra fruit harvesting machine at work, according to one embodiment of the invention.

FIG. 3 schematically illustrates a sabra fruit harvesting machine 100, according to one embodiment of the invention.

FIG. 4 is a zoomed view thereof.

FIG. 5 schematically illustrates a sabra fruit harvesting machine 100 which further details the operation of the machine, according to one embodiment of the invention.

FIG. 6 schematically illustrates a sucking mechanism of a sabra fruit harvesting machine 100, according to one embodiment of the invention.

FIGS. 7a and 7b demonstrate the action of the ladder, according to one embodiment of the invention.

FIG. 8 schematically illustrates a fruit cutting device, according to one embodiment of the invention.

It should be understood that the drawings are not necessarily drawn to scale.

### DETAILED DESCRIPTION

The invention will be understood from the following detailed description of embodiments, which are meant to be descriptive and not limiting. For the sake of brevity, some well-known features, methods, systems, procedures, components, circuits, and so on, are not described in detail.

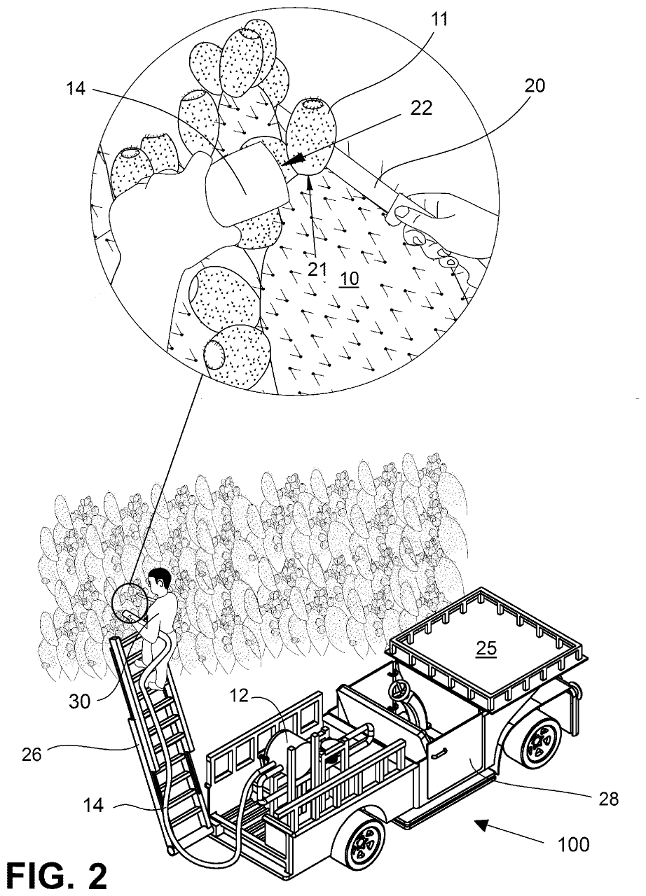

FIG. 2 schematically illustrates a sabra fruit harvesting machine at work, according to one embodiment of the invention.

The harvesting machine, which is marked herein by reference numeral 100, comprises a sealed container 12 for fruit collection; a flexible tube 14 connected to the sealed container 12, wherein the inlet 22 of the suction tube is several millimeters larger than the diameter of a fruit in order to allow “swallowing” of the fruit into the tube.

Vacuum pump connected to the sealed container 12 draws the air of flexible tube 14 into the sealed container 12 thereby pulling a fruit placed at the inlet of the tube into the sealed container 12, where it is accumulated.

A user approaches the inlet 22 of flexible tube 14 to a sabra fruit 11, and cuts with a cutting device 27, such as a knife or an oriented device, the fruit at the location 21 where the sabra fruit 11 connects to the sabra plant 10. Due to the suction, the fruit 10 is drawn into the sealed container 12, where it is stored.

The suction mechanism, i.e., the vacuum pump and the sealed container, are placed on a vehicle 28. A ladder 26 is installed on the vehicle 28. The user that harvests the fruits stands on the ladder 26, while another user (not illustrated) drives the vehicle 28.

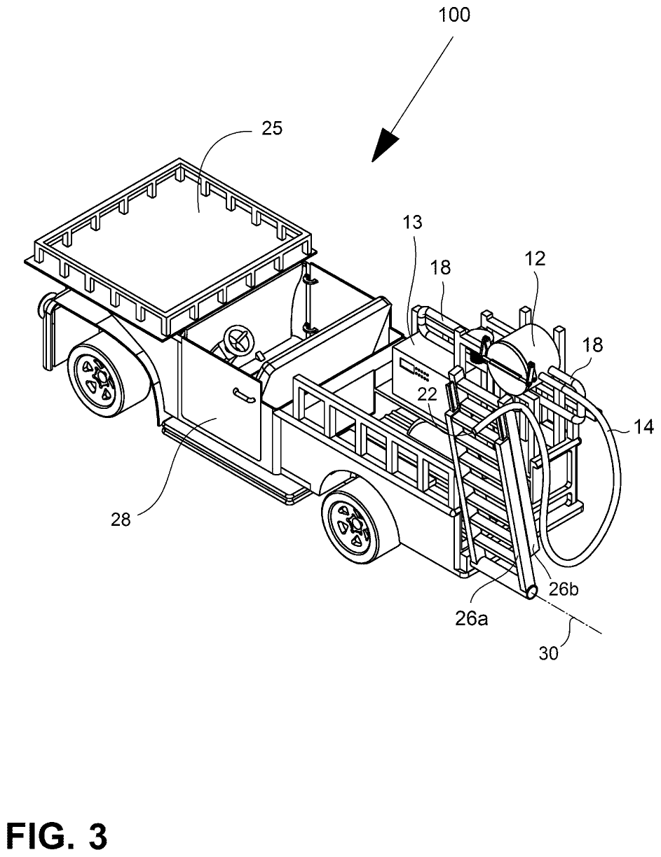

FIG. 3 schematically illustrates a sabra fruit harvesting machine 100, according to one embodiment of the invention.

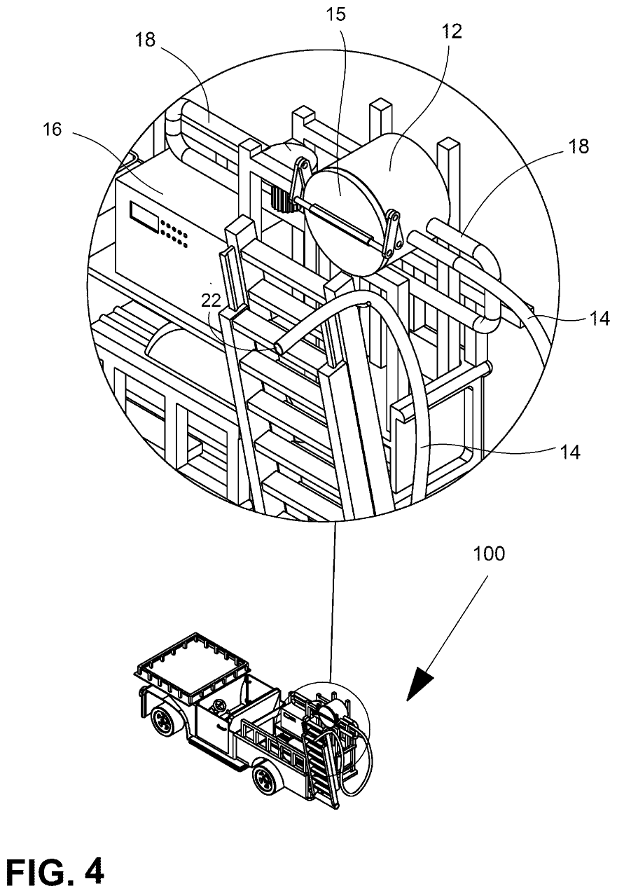

FIG. 4 is a zoomed view thereof.

The machine comprises vacuum pump 13 that sucks air from a flexible tube 14 through a sealed container 12 in which the collected fruits are stored. Thus, by placing a fruit at the inlet 22 of the flexible tube 14, it is sucked into the sealed container 12.

Reference numeral 15 denotes a door of the sealed container 12. Tube 18 connects the vacuum pump 13 to the sealed container 12.

This mechanism is placed on a vehicle 28.

The vehicle also comprises a ladder, which has two adjusting abilities: The ladder can be elongated (part 26b can be shifted with reference to part 26a of the ladder), and additionally its tilt is also adjustable by changing the angle along its axis 30.

Platform 25 is used to place thereon filled and empty fruit boxes, tools, etc.

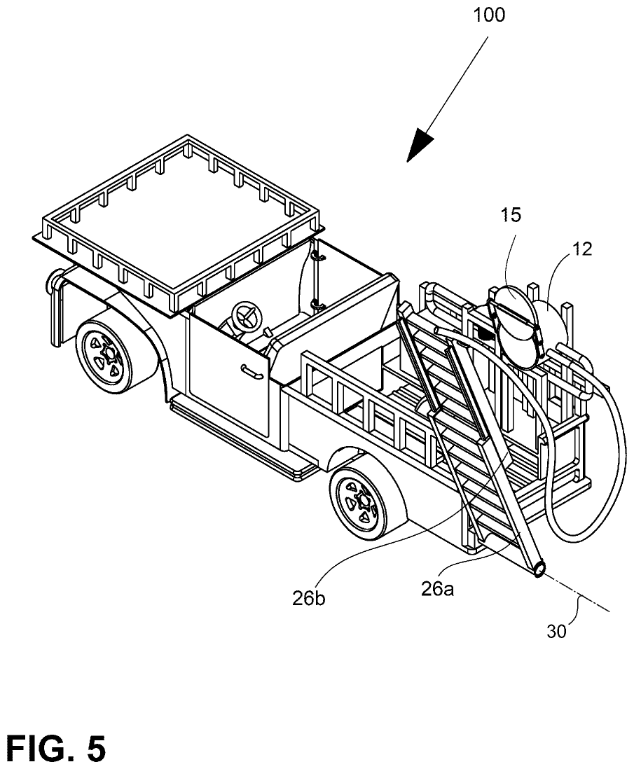

FIG. 5 schematically illustrates a sabra fruit harvesting machine 100 which further details the operation of the machine, according to one embodiment of the invention.

In this figure, the ladder expands by shifting part 26b of the ladder upwards, with reference to part 26a of the ladder.

In addition, the door 15 of the sealed container 12 is open.

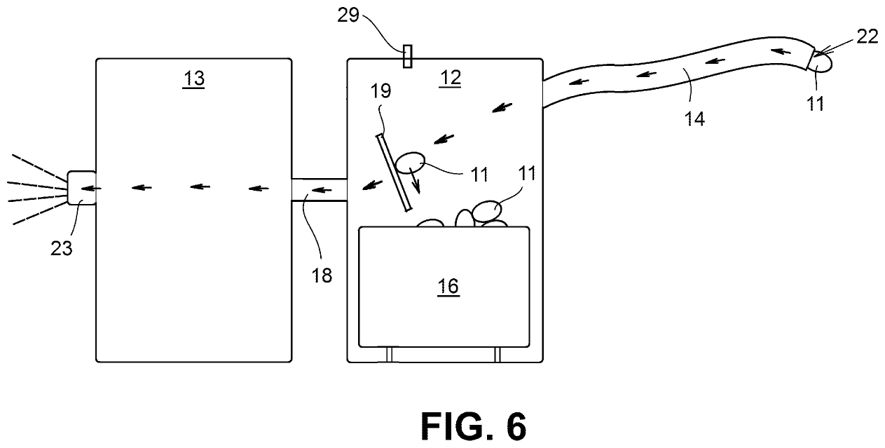

FIG. 6 schematically illustrates a sucking mechanism of a sabra fruit harvesting machine 100, according to one embodiment of the invention.

The mechanism comprising a vacuum pump 13, which is connected via tube 18 to a sealed container 12, used for collecting fruits. To the sealed container 12 is connected a flexible tube 14. The inlet to flexible tube 14 is marked herein by reference numeral 22.

The vacuum pump 13 draws air through the inlet 22 of flexible tube 14. Upon placing a fruit 11 at the inlet 22 of flexible tube 14 and disconnecting the fruit from the plant, it is sucked into the sealed container 12. On its way, fruit 11 meets barrier 19, which stops and softens its fall, and directs its fall into basket 16, which is placed into the sealed container 12.

Once in a while, the collecting basket 16 is taken out, and an empty basket 16 replaces it.

The pumped air enters into the vacuum pump 13 via tube 18, and exits from the vacuum pump via outlet 23 thereof.

Reference numeral 29 denotes a vacuum released valve. This is useful for allowing easy opening of door 15. More particularly, the valve eliminates the sealing of the sealed container by generating an open aperture in the sealed container.

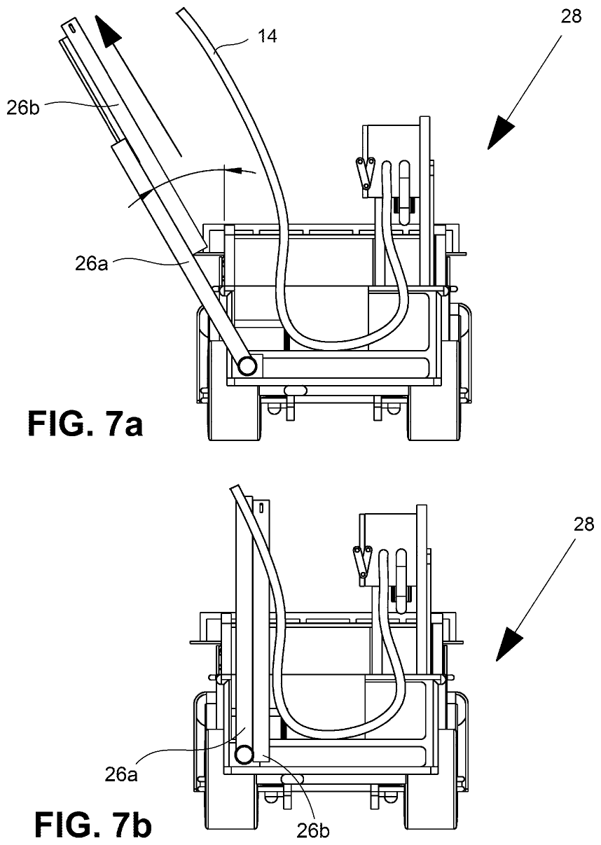

FIGS. 7a and 7b demonstrate the action of the ladder, according to one embodiment of the invention.

In FIG. 7a part 26b of the ladder moves upwards, thereby expending the length of the ladder.

In FIG. 7b part 26a of the ladder is vertical, while in FIG. 7a it is inclined. Thus, a user can adjust both, the height of the ladder and its inclination, thereby allowing placing the ladder in such a way that his work will be eased.

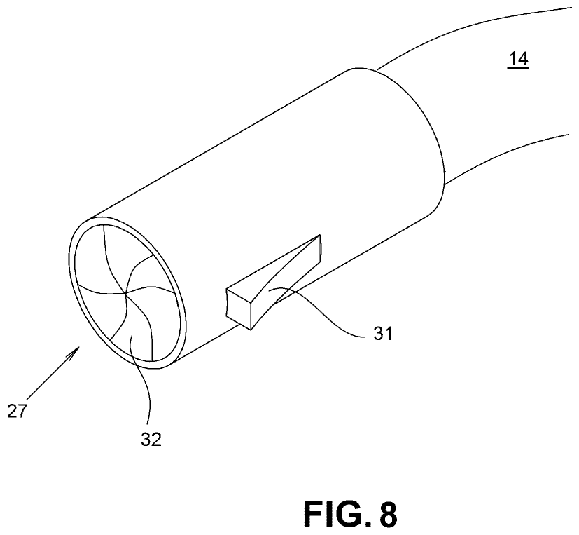

FIG. 8 schematically illustrates a fruit cutting device, according to one embodiment of the invention.

The cutting device, which is marked herein by reference numeral 27, comprises a cutting tool 32 (such as scissors, a shutter, a rotating blade, etc.) and an activation element 31 such as a button (in the case the mechanism is electric), a lever (in the mechanism is mechanical), etc. Thus, a user places the fruit into the cutting device 27, presses the activation element 31, and the cutting tool 32 cuts the fruit from the plant.

The invention eases the physical harvesting work, provides easy access to fruits to be harvested, diminishes the fruits depreciation, un-necessitates the need to carry a ladder and a pail, allows to concentrate “large” amounts of fruits on the platform of the vehicle, and transporting it to the concentration site. In particular, when it comes to sabra, it helps a worker to avoid contacting with sabra thorns.

Despite of the fact that the examples herein refer to sabra, it should be noted that the same mechanism can also be implemented for harvesting apples, plums, peaches, oranges, clementine, lemons, Chinese oranges, tomatoes, peppers, strawberries, olives, and other, whether they comprise a stalk or not.

These benefits are essential since there is a short time to harvest the fruits and send them to the market. If the fruits are not shipped on time, their shelf life is shortened, which means damage to the farmer.

In the figures and/or description herein, the following reference numerals (Reference Signs List) have been mentioned:
100—a fruit harvesting machine;
10—a sabra plant;
11—a sabra fruit;
12—a sealed container for collecting harvested fruits;
13—a vacuum suction pump;
14—a flexible tube;
15—a door of the sealed container 12;
16—a fruits collecting basket;
17—a thorn;
18—a tube connecting vacuum pump 13 with a sealed container 12;
19—a barrier for blocking and softening a fall of a fruit;
20—a cutting knife;
21—a location where a fruit connects to its plant;
22—an inlet to flexible tube 14;
23—an air outlet from the vacuum pump 13;
25—a platform for placing thereon fruit boxes, tools, etc.;
26—a ladder;
26a—a ladder whose tilt is adjustable;
26b—a ladder whose height is adjustable;
27—a cutting device;
28—a vehicle;
29—a vacuum release valve;
30—a ladder rotation axis;
31—an activation element; and
32—a cutting tool.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A fruit harvesting machine, comprising:
a sealed container (12), for collecting fruits;
a vacuum pump (13), connected to said sealed container (12), for generating a vacuum in said sealed container (12);
a flexible tube (14), connected to said sealed container (12), for drifting therethrough a fruit;
a vehicle (28) on which said sealed container is placed on;
a cutting device (27) located at the end (22) of said flexible tube (14), inside said tube; and
a ladder (26) installed on said vehicle (28), wherein a length and tilt of said ladder being adjustable,
thereby allowing harvesting fruits without direct contact between a harvester and said fruits.

2. A machine according to claim 1, wherein said cutting device (27) is mechanical.

3. A machine according to claim 1, wherein said cutting device (27) is electrical.

4. A machine according to claim 1, wherein said cutting device (27) is employing a rotating blade.

5. A machine according to claim 1, wherein said cutting device (27) is employing a shutter.

6. A machine according to claim 1, wherein said cutting device (27) is employing scissors.

7. A machine according to claim 1, further comprising a vacuum release valve (29), for allowing releasing a door to said vacuum container.

8. A machine according to claim 1, further comprising a door (15) for inserting therethrough a collecting basket (16) into said sealed container (12).

9. A machine according to claim 1, further comprising a barrier (19) installed in a space of said sealed container, for blocking and softening a fall of a fruit (11) into said sealed container (12).

10. A machine according to claim 1, adapted to harvest a fruit selected from a group consisting of: apple, plum, peach, orange, clementine, lemon, Chinese orange, tomato, pepper, strawberry, and olive.

11. A machine according to claim 1, adapted to harvest a sabra fruit.

12. A fruit harvesting method, comprising:
providing a sealed container (12), for collecting fruits;
providing a vacuum pump (13), connected to said sealed container (12), for generating a vacuum in said sealed container (12);
providing a flexible tube (14), connected to said sealed container (12);
approaching an end of said tube (14) to a fruit; and
drifting said fruit into said tube,
thereby allowing harvesting fruits without a direct contact between a harvester and said fruits.

13. A method according to claim 12, further comprising the step of:
installing a cutting device (27) at an end (22) of said flexible tube (14), and inside said tube; and
cutting said fruit by said cutting device,
thereby allowing cutting by said cutting device a fruit without touching said fruit by a harvester thereof.
